(19) United States
(12) Patent Application Publication
(10) Pub. No.: US 2010/0297383 A1
(43) Pub. Date: Nov. 25, 2010

(54) ORNAMENTAL SHEET AND METHOD FOR PRODUCING SAME

(75) Inventor: Ryuji Aoyama, Aichi (JP)

Correspondence Address: GRAYBEAL JACKSON LLP, 400 - 108TH AVENUE NE, SUITE 700, BELLEVUE, WA, 98004, US

(73) Assignee: KABUSHIKI KAISHA AOYAMA, Nagoya-shi, Aichi (JP)

(21) Appl. No.: 12/863,582

(22) PCT Filed: Jun. 16, 2008
(86) PCT No.: PCT/JP2008/060949

§ 371 Date: Jul. 19, 2010

(30) Foreign Application Priority Data
Jan. 17, 2008 (JP) 2008-008087

(51) Int. Cl. D06Q 1/14; B44C 3/12

(52) U.S. Cl. 428/67; 156/251

(57) ABSTRACT

An embodiment provides an ornamental sheet and a method of manufacturing the ornamental sheet, wherein an ornamental pattern for use in ornamenting a fabric product may be easily peeled off from a film when using the ornamental pattern. A laser beam is applied while moving it along the contour of a pattern on a surface. By this, a synthetic fiber sheet piece with the pattern printed is cut out of a synthetic fiber sheet. When cutting out, a cut line (groove) is formed in the film to extend to the vicinity of the bottom face of the film by heat due to the irradiation with a laser beam. Also, a periphery of an adhesive layer of the synthetic fiber sheet is welded to the film, and a periphery, which is close to the periphery through the cut line, of the adhesive layer of the synthetic fiber sheet is welded to the film.

### PRIORITY CLAIM

The present application is a United States national phase application filed pursuant to 35 USC §371 of International Patent Application Serial No. PCT/JP2008/060949, entitled DECORATIVE SHEET AND PROCESS FOR PRODUCING THE DECORATIVE SHEET, filed Jun. 16, 2008; which application claims priority to Japanese Patent Application Serial No. 2008-008087, filed Jan. 17, 2008; which foregoing applications are incorporated herein by reference in their entireties.

### TECHNICAL FIELD

An embodiment of the present invention relates to an ornamental sheet with an ornamental body having a pattern for use in ornamenting a fabric product such as a curtain, clothing and the like as well as a method for manufacturing the sheet.

### BACKGROUND

Heretofore, an ornamental sheet has been used as a means to ornament a fabric product. Some of the ornamental sheets, when used, are easily attached to the surface of the fabric product by the heat of an iron and the like (e.g., see JP Utility Model Registration No. 3135803 and incorporated herein by reference). The ornamental sheet has an ornamental pattern printed on its surface and is provided with a discontinuity including a series of cut lines along the contour of the ornamental pattern.

However, when separating the ornamental pattern from the ornamental sheet along the discontinuity, if the cut lines thereof are shallow, there are cases where the sheet cannot be cut finely along the discontinuity as the direction of force applied to the ornamental sheet is not always constant. There are also cases where, depending on a force used when separating the ornamental pattern from the ornamental sheet, the ornamental pattern itself cannot be separated along the discontinuity but is instead torn off.

A possible solution to the above problem is to provide an ornamental sheet for a user in a state that an ornamental pattern is pre-separated. Where the pattern is elongated, however, the pattern itself is often twisted or curled such that it looks unattractive as an article for sale. Thus, some support medium for keeping the ornamental pattern flat is often required at the time of delivery.

A common method for supporting the ornamental pattern on the support medium is to bond the ornamental pattern and the support medium together with an adhesive. However, when the ornamental pattern includes an adhesive layer (hereinafter called “fabric adhesive layer”) for adhering the pattern to a fabric product, it is often undesirable to provide the ornamental pattern with an adhesive layer (hereinafter called “support medium adhesive layer”) including an adhesive for adhering the ornamental pattern to the support medium, because the adhesive of the support medium adhesive layer may infiltrate the adhesive of the fabric adhesive layer, and thus may possibly weaken the adhesive strength of both adhesives due to a chemical change caused by bonding of the adhesives of the support medium adhesive layer and the fabric adhesive layer.

Therefore, a possible solution is to use the adhesive of the fabric adhesive layer for adhering the ornamental pattern to the support medium. However, since the adhesive of the fabric adhesive layer aims to adhere the fabric product to the ornamental pattern, the adhering force is generally great, and when the adhesive of the fabric adhesive layer is used for adhering the ornamental pattern to the support medium, a force as strong as or stronger than the adhering force of the adhesive to the fabric adhesive layer may be required for peeling off the ornamental pattern from the support medium, so that the ornamental pattern may not be easily peeled off from the support medium.

### SUMMARY

An embodiment of the present invention is an ornamental sheet having an ornamental pattern and a support medium therefor and a method of manufacturing the ornamental sheet, wherein the ornamental pattern can be supported on the support medium by using an adhesive layer for adhering the ornamental pattern to a fabric product and also can be easily peeled off from the support medium when using the ornamental pattern.

An embodiment of an ornamental sheet comprises: a synthetic fiber sheet with at least one pattern printed on its surface; a thermoplastic resin adhesive layer applied to the reverse side of the synthetic fiber sheet; and a film adhered to a part of the adhesive layer, wherein the synthetic fiber sheet includes a first synthetic fiber sheet piece having the pattern and a second synthetic fiber sheet piece surrounding the first synthetic fiber sheet piece. The film may be adhered in the periphery of the adhesive layer of the first synthetic fiber sheet piece.

An embodiment of an ornamental sheet comprises at least one synthetic fiber sheet with a pattern printed on its surface, a thermoplastic resin adhesive layer applied to the reverse side of the synthetic fiber sheet, and a film adhered to a part of the adhesive layer. An embodiment of an ornamental sheet comprises: a synthetic fiber sheet with a pattern printed on its surface and having an ornamental contour of the pattern; a thermoplastic resin adhesive layer applied to the reverse side of the synthetic fiber sheet; and a film adhered to a part of the adhesive layer and having the same contour as the ornamental contour. Also, the film may be adhered to the periphery of the adhesive layer.

The above-mentioned film may be transparent. The adhesive may include a pressure-sensitive adhesive.

An embodiment of a method for manufacturing an ornamental sheet comprises: printing at least one pattern on the surface of a synthetic fiber sheet; providing a thermoplastic resin adhesive layer on the reverse side of the synthetic fiber sheet; attaching a film to the adhesive layer; while cutting the pattern out of the synthetic fiber sheet by laser beam, adhering the film to the adhesive layer at the cut-out portion of the synthetic fiber sheet.

An embodiment of a method of production may comprise a step of removing the synthetic fiber sheet around the cut-out pattern. Also, an embodiment of a method of production may comprise a step of forming a cut line in the film along the contour of the pattern. Cutting the pattern out of the synthetic fiber sheet may include cutting the film along the cut line.

According to an embodiment of a ornamental sheet, since only a portion of the thermoplastic resin adhesive layer applied to the reverse side of the synthetic fiber sheet is used to adhere the synthetic fiber sheet with the pattern printed and the film, the adhesive strength between the synthetic fiber sheet and the film is weaker than when the whole adhesive layer is used, but it is sufficient for the film to support the synthetic fiber sheet adhered to the film, while the synthetic fiber sheet may be easily peeled off from the film.

In an embodiment where the film is adhered at the periphery of the adhesive layer, an area of adhesion to the film is small, its adhesive strength is weaker than when the film is adhered to the whole surface of the adhesive layer, so that the synthetic fiber sheet may be easily peeled off from the film.

If the film is transparent, then various designs may be sought for by placing freely the synthetic fiber sheet adhered to the film on a fabric product such as clothing and the like before adhering it directly to the fabric product.

According to an embodiment of a method for manufacturing an ornamental sheet, since a thermoplastic resin adhesive for adhering a cut-out portion of a synthetic fiber sheet to a film by a laser beam is only an adhesive melted by laser beam heat in the vicinity of the cut-out portion, the adhesive strength is weaker than when the whole adhesive is used to adhere the synthetic fiber sheet and the film, but is enough to adhere and support the cut-out pattern to and on the film, while the cut-out pattern may be easily peeled off from the film.

### BRIEF DESCRIPTION OF DRAWINGS

FIGS. 1 (A) and (B) are enlarged sections illustrating an embodiment of a method for manufacturing an embodiment of an ornamental sheet, and (C) is an enlarged section illustrating a state where a discontinuity is provided in the film in (A) instead of a groove shown in (B).

FIG. 2 A partial plan view showing a first embodiment of an ornamental sheet.

FIG. 3 A view showing a state of peeling off a masking sheet from the ornamental sheet in FIG. 2.

FIG. 4 A partial plan view showing a second embodiment of an ornamental sheet.

FIG. 5 An enlarged section with the ornamental sheet in FIG. 4 cut out along the line 5-5.

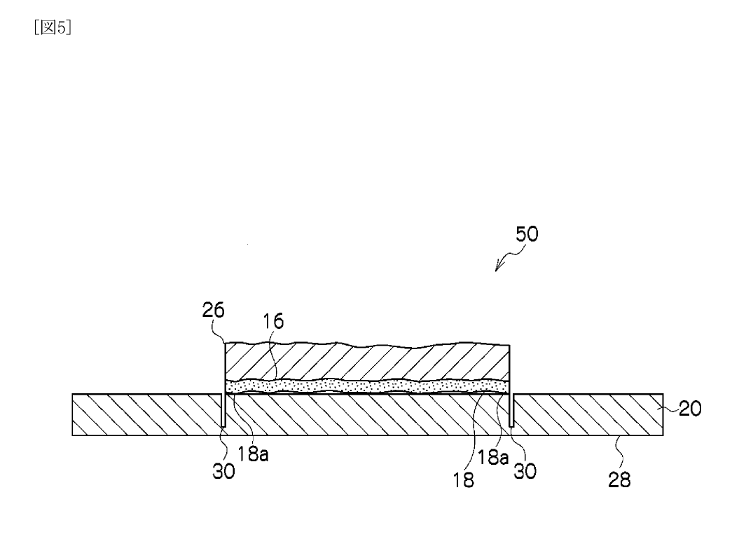

FIG. 6 A partial plan view showing a third embodiment of an ornamental sheet.

FIG. 7 An enlarged section with the ornamental sheet in FIG. 6 cut out along the line 7-7.

### LIST OF REFERENCE NUMBER FOR AN EMBODIMENT

10 synthetic fiber sheet
12 surface
14a, 14b, 14c, 14d pattern
16 reverse side
18 adhesive layer
18a, 18b periphery
20 film
26 synthetic fiber sheet piece (first synthetic fiber sheet piece)
26a, 26b, 26c, 26d ornamental body
30 groove (cut line)
32 masking sheet (second synthetic fiber sheet piece)
40, 50, 60 ornamental sheet

### DETAILED DESCRIPTION

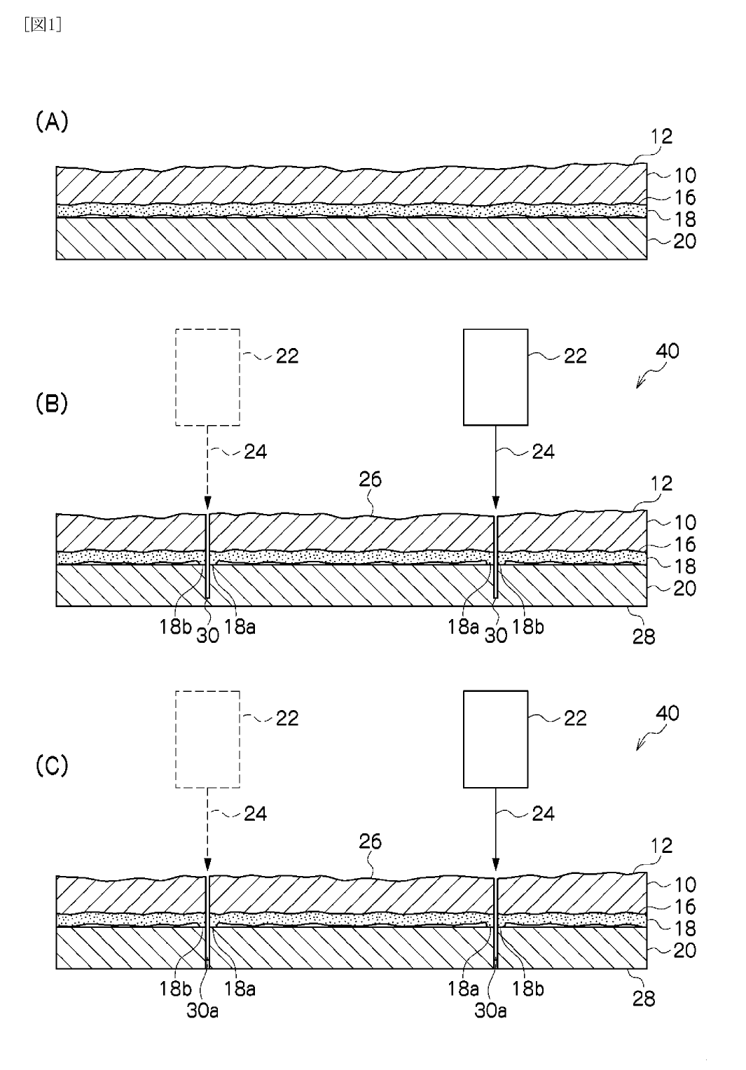

Referring to FIG. 1, a sectional view of an embodiment of an ornamental sheet is schematically shown to explain an embodiment of a method for manufacturing an ornamental sheet.

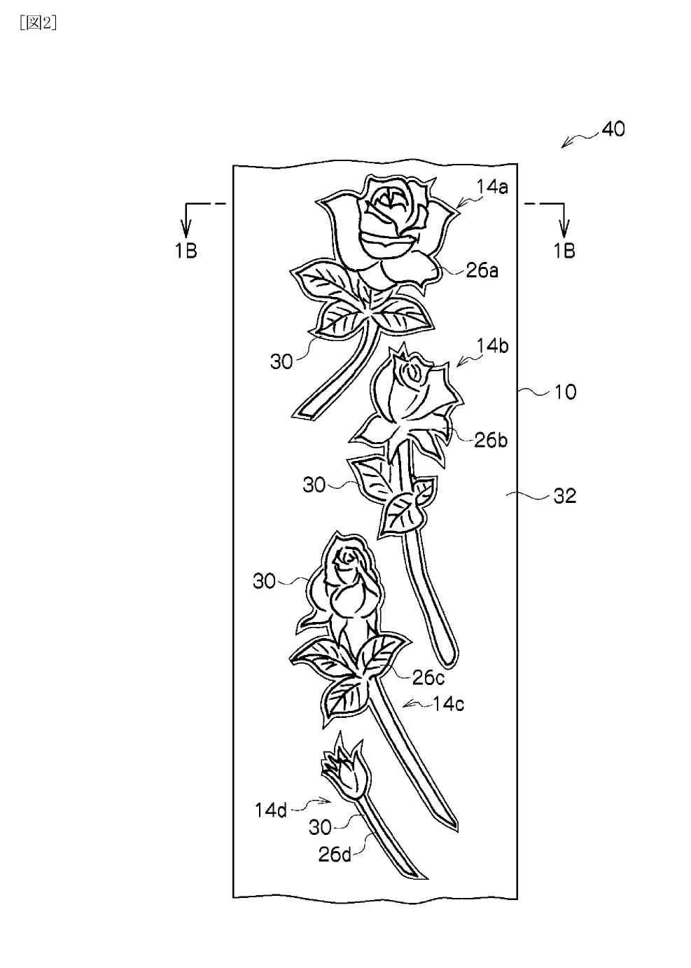

As shown in FIG. 1(A), a pattern 14a (FIG. 2) is printed on the surface 12 of the synthetic fiber sheet 10, an adhesive layer 18 is provided by applying a thermoplastic resin adhesive to the reverse side 16 of the synthetic fiber sheet 10, and a transparent film 20 of polyester resin is attached to the adhesive layer 18.

Next, as shown in FIG. 1(B), a laser beam 24, while being moved along the contour of a pattern 14a on the surface 12, is applied from a laser system 22. Thereby, a synthetic fiber sheet piece 26 with the pattern 14a printed is cut out of the synthetic fiber sheet 10.

The illustrated example, where the laser device 22 and the laser beam 24 are indicated in solid line and dotted line, shows a state of moving the laser beam 24 as indicated by the solid line along the contour of the pattern 14a to the position of the laser beam 24 as indicated by the dotted line.

When cutting out, in the cut-out portion of the synthetic fiber sheet piece 26 and the cut-out portion of the synthetic fiber sheet 10, a cut line (groove) 30 is formed in the film 20 to extend to the vicinity of the bottom face 28 of the film 20 by the heat due to irradiation with the laser beam 24. At the same time, the periphery 18a of the adhesive layer 18 of the synthetic fiber sheet piece 26 is melted by the heat due to the irradiation with the laser beam 24 and welded to the film 20, and the periphery 18b of the adhesive layer 18 of the synthetic fiber sheet 10, which is proximate to the periphery 18a through the cut line 30, is also melted by the heat due to the irradiation with the laser beam 24 and is welded to the film 20.

The adhesive layer 18 is not melted by the heat due to the irradiation with the laser beam 24 and is not adhered to the film 20, except the peripheries 18a, 18b.

The synthetic fiber sheet piece 26 forms an ornamental body (indicated by reference numerals 26a, 26b, 26c, 26d in FIG. 2) to be used for ornamenting articles including fabric products such as curtain, clothing and the like. Also, the remaining synthetic fiber sheet 10, which is left after the synthetic fiber sheet piece 26 is cut out, forms a masking sheet 32 (FIG. 2) for protecting the film 20 around the synthetic fiber sheet piece 26.

Incidentally, by adjusting the intensity of the laser beam, the depth of the groove 30 formed in the film 20 may be adjusted; therefore, as shown in FIG. 1(C), for example, by repeating the intensity of the laser beam 24 strongly and weakly like a pulse, a discontinuity 30a including cut lines 30 continuing at intervals can be formed in the film 20. Furthermore, by enlarging the beam diameter of the laser beam 24, wide cut lines may be formed. Also, a hot-melt adhesive as well as a pressure-sensitive type adhesive (PSA) may be used as thermoplastic resin adhesive.

An ornamental sheet 40 produced by an embodiment of a method of manufacturing which was explained with reference to FIGS. 1(A) and (B) is now explained as Example 1 of an embodiment of a ornamental sheet. In FIG. 2, a partial plan view of the ornamental sheet 40 is schematically shown. Incidentally, FIG. 1(B) is an enlarged sectional view cut along the line 1B-1B in FIG. 2.

The illustrated ornamental sheet 40 comprises a synthetic fiber sheet 10 with four rose patterns 14a, 14b, 14c, 14d printed on its surface 12, and a film 20 (FIG. 1) which is attached to the reverse side 16 of the synthetic fiber sheet 10.

The synthetic fiber sheet 10 has the ornamental bodies 26a, 26b, 26c, 26d (indicated by the reference sign 26 in FIG. 1), respectively, having the flower patterns 14a, 14b, 14c, 14d, and a masking sheet 32 (corresponding to the synthetic fiber sheet 10 excluding the synthetic fiber sheet piece 26 in FIG. 1) covering to protect the film 20 around these ornamental bodies.

The ornamental bodies 26a, 26b, 26c, 26d, respectively, have ornamental contours of roses and the thermoplastic resin adhesive layer 18 (FIG. 1) applied to their reverse sides and are adhered to the film 20 at the periphery 18a of the adhesive layer 18.

The masking sheet 32 is provided with the thermoplastic resin adhesive layer 18 (FIG. 1) applied to its reverse side and is adhered to the film 20 at the periphery 18b of the adhesive layer 18.

The ornamental bodies 26a, 26b, 26c, 26d, respectively, which are cut out of the synthetic fiber sheet 10, are separated from the masking sheet 32 by the groove 30. Incidentally, the bottom face of the illustrated groove 30 shows the film 20.

Next, an ornamental sheet 50 is a second example of an embodiment of an ornamental sheet and its production method are described below.

By peeling off the masking sheet 32 from the film 20, leaving the ornamental bodies 26a, 26b, 26c, 26d, an ornamental sheet 50, different from the ornamental sheet 40, is produced.

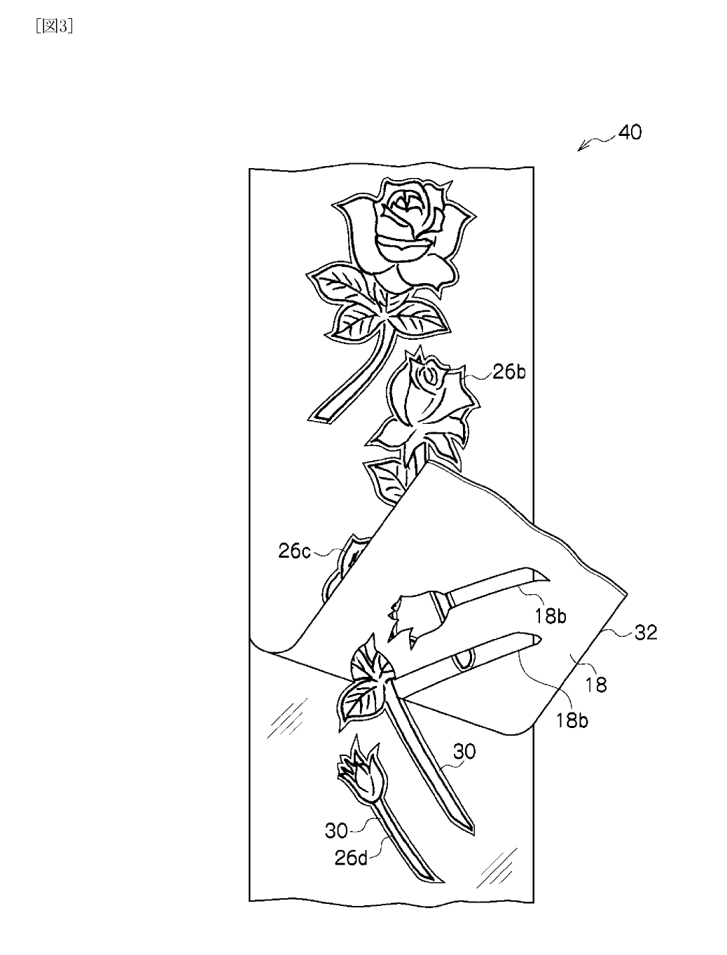

FIG. 3 is a view showing a state in which the masking sheet 32 is being peeled off the ornamental sheet 40 in FIG. 2. Since the masking sheet 32 is only stuck on the film 20 through the periphery 18b of the adhesive layer 18 provided on its reverse side, the adhesion between the masking sheet 32 and the film 20 is weaker than when the masking sheet 32 is stuck on the film 20 through the whole surface of the adhesive layer 18. Thus, a user may easily peel the masking sheet 32 off the film 20 by grasping an end portion of the masking sheet 32, turning it over, and pulling it out from the film 20.

Next, an embodiment of a method for manufacturing an ornamental sheet 60 that is an example of a third embodiment, and the ornamental sheet 60, are described.

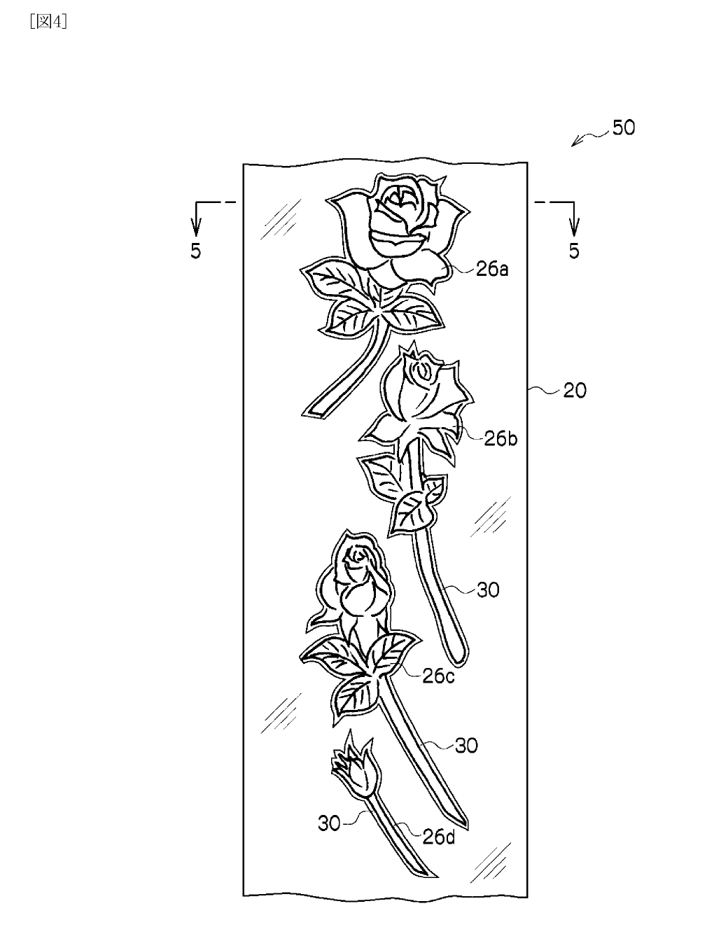

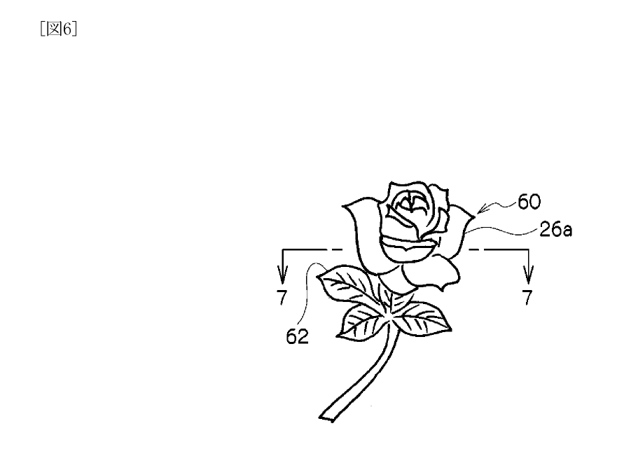

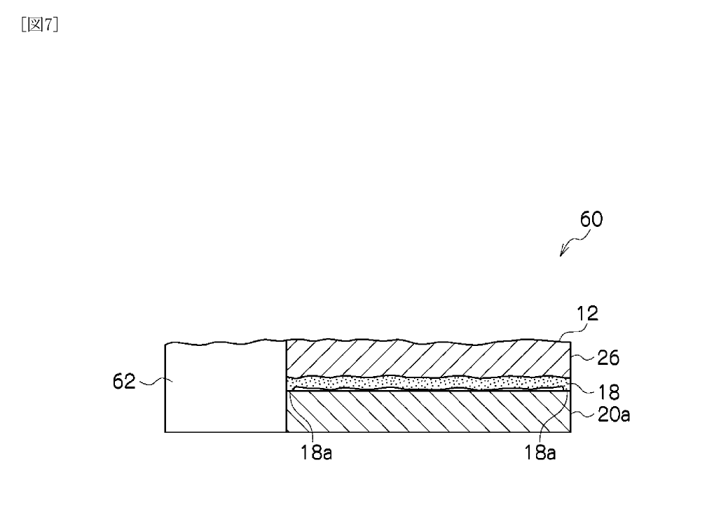

In FIG. 6 is a partial plan view of a cut-out ornamental body 26a and a film piece 20a obtained by cutting off the film 20 from the ornamental sheet 40 in FIG. 2 or from the ornamental sheet 50 in FIG. 4 along the groove 30. FIG. 7 is an enlarged section obtained by cutting off along the line 7-7 in FIG. 6 and shown together with a side portion 62, which forms a leaf, of the ornamental body 26a. Incidentally, in FIGS. 6 and 7, the same reference signs are assigned to the components explained in FIGS. 1 through 3, explanations of which are omitted.

In one example of an embodiment of a method for using the ornamental sheets 40, 50, a user applies force to the film 20 along the groove 30 of the film 20 to peel the ornamental body 26a off the film 20 of the ornamental sheets 40, 50. In this case, since only a part of the adhesive layer 18 is used for adhering the ornamental body 26a and the film 20, the adhesive strength therebetween is weaker than when the whole adhesive layer is used; therefore, while it is sufficient to have the ornamental body 26a adhered to the film 20 and supported on the film 20, it is easy to peel the ornamental body 26a off the film 20. The peeled ornamental body 26a is disposed in a desired position of a fabric product such as clothing. The ornamental body 26a thus disposed is pressed against the fabric product with heating means such as an iron and is adhered to the fabric product by melting the adhesive layer 18 by the iron heat.

Since the film 20 is transparent, various designs may be sought for by placing the ornamental body 26a freely on the fabric product before adhering.

Also, in an example of an embodiment of a method for using the ornamental sheet 60, a user sets a desired position by placing the ornamental sheet 60 on a fabric product such as clothing. Then, the user peels the ornamental body 26a off the film piece 20a. In this case, since only a part of the adhesive layer 18 is used for adhering the ornamental body 26a and the film 20, the adhesive strength between the ornamental body 26a and the film piece 20a is weaker than when the whole adhesive layer 18 is used. Therefore, while it is sufficient to adhere the ornamental body 26a to the film piece 20a and to support the former on the latter, the ornamental body 26a may be easily peeled off the film piece 20a. The peeled ornamental body 26a is disposed at a previously set desired position. The arranged ornamental body 26a is pressed against the fabric product with heating means such as an iron and adhered to the fabric product by melting the adhesive layer 18 by the iron heat.

In the above-mentioned first to third examples (and possibly in other examples), the synthetic fiber sheet may be cloth made of synthetic fiber such as nylon fiber and polyester fiber, cloth made of chemical fiber such as acetate, cloth made of natural fiber and the like, nonwoven cloth, or artificial leather.

Also, while a transparent film of polyester resin was used as the film, in an embodiment it is possible to use any material, so long as it is transparent, and its thickness may be set at, for example, about 100-300 μm.

Further, while a film was adhered to the periphery of the adhesive layer, in an embodiment it may be adhered to whichever part of the adhesive layer so long as the ornamental body, when used, may be easily peeled off the film. This adhesive layer may be impregnated with a foamable resin to make a cubic ornamental body.

Also, while a rose flower pattern was used, various patterns such as other patterns of plant, animal, and the like are applicable.

The present disclosure is not limited to the above examples, but may be variously modified without departing from the spirit and scope of the present disclosure.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. An ornamental sheet comprising:
a synthetic fiber sheet with at least one pattern printed on its surface;
a thermoplastic resin adhesive layer applied to the reverse side of the synthetic fiber sheet; and
a film adhered to a part of the adhesive layer;
wherein the synthetic fiber sheet includes a first synthetic fiber sheet piece including the pattern, and a second synthetic fiber sheet piece surrounding the first synthetic fiber sheet piece

2. An ornamental sheet comprising:
at least one synthetic fiber sheet with a pattern printed on its surface;
a thermoplastic resin adhesive layer applied to the reverse side of the synthetic fiber sheet; and
a film adhered to a part of the adhesive layer.

3. An ornamental sheet comprising:
a synthetic fiber sheet with a pattern printed on its surface and having an ornamental contour of the pattern;
a thermoplastic resin adhesive layer applied to the reverse side of the synthetic fiber sheet; and
a film adhered to a part of the adhesive layer and having the same contour as the ornamental contour.

4. The ornamental sheet defined in claim 1, wherein the film is adhered in the periphery of the adhesive layer of the first synthetic fiber sheet piece.

5. The ornamental sheet defined in claim 2, wherein the film is adhered in the periphery of the adhesive layer.

6. The ornamental sheet defined in claim 1, wherein the film is transparent.

7. The ornamental sheet defined in claim 1, wherein the adhesive includes a pressure-sensitive adhesive.

8. A method of manufacturing an ornamental sheet, comprising steps of:
printing at least one pattern on the surface of a synthetic fiber sheet;
providing a thermoplastic resin adhesive layer on the reverse side of the synthetic fiber sheet;
attaching a film to the adhesive layer; and
while cutting the pattern out of the synthetic fiber sheet by laser beam, adhering the film to the adhesive layer at a cut-out portion of the synthetic fiber sheet.

9. A method defined in claim 8, comprising a step of removing the synthetic fiber sheet around the cut-out pattern.

10. A method defined in claim 8, comprising a step of forming a cut line in the film along the contour of the pattern.

11. A method defined in claim 10, wherein a step of cutting the pattern out of the synthetic fiber sheet is carried out by cutting the film along the cut line.

12. The ornamental sheet defined in claim 3, wherein the film is adhered in the periphery of the adhesive layer.

13. The ornamental sheet defined in claim 2, wherein the film is transparent.

14. The ornamental sheet defined in claim 3, wherein the film is transparent.

15. The ornamental sheet defined in claim 2, wherein the adhesive includes a pressure-sensitive adhesive.

16. The ornamental sheet defined in claim 3, wherein the adhesive includes a pressure-sensitive adhesive.
